(19) United States
(12) Patent Application Publication
(10) Pub. No.: US 2010/0072758 A1
(43) Pub. Date: Mar. 25, 2010

(54) On-Road Energy Conversion and Vibration Absorber Apparatus

(76) Inventors: Hung-Wei CHANG, Banciao City (TW); Chih-Yang LEE, Banciao City (TW)

Correspondence Address: HDLS Patent & Trademark Services, P.O. BOX 220746, CHANTILLY, VA, 20153-0746, US

(21) Appl. No.: 12/234,624

(22) Filed: Sep. 20, 2008

(51) Int. Cl. H02K 7/18; F03G 1/00; F16F 13/00

(52) U.S. Cl. 290/1 R; 267/103; 267/118; 404/71

(57) ABSTRACT

An on-road energy conversion and vibration absorber apparatus receives the kinetic energy from moving vehicles and pedestrians when being weighed down, and converts the received kinetic energy into a static energy using a restorable elastic element compressing a fluid thereby storing the static energy in a pressure chamber, and then conducting the pressurized fluid to pass though a check valve along a conduit and drive a vane wheel by releasing its static energy. The vane wheel in turn drives a generator to generate electric energy, the vibration of the vehicles is alleviated by cushion effect provided by the apparatus.

### BACKGROUND OF THE INVENTION

1. Field of the Invention

The present invention relates to an on-road energy conversion and vibration absorber apparatus in which the kinetic energy received from moving vehicles (including motorcycles and bicycles) and pedestrians are converted into a static energy using a restorable elastic element to compress and pressurize a fluid, and then to drive a vane wheel by releasing the pressure of the pressurized fluid. The vane wheel in turn drives a generator to generate electric energy.

2. Description of the Prior Art

Continuous rising of the oil cost has been affecting the economy in the whole world that the problems of environmental protection, energy saving, carbon reduction and anti-global green house effect have drawn more attention of the people than ever. At the same time, the development of new and non-contamination energy source is a paramount importance in the present day.

As it is well-known, the traditional steam power plant produces a large amount of carbon dioxide which aggravates the green house effect, the hydraulic power plant is destructive to natural environment in construction and power supply is not reliable during low water periods, and the nuclear power plant is said to be the most threatful to the security. The wind power and solar light are considered to be the new hope of two clean energy sources. However, the both are sometimes geographically restrictive by reason of local climate.

The inventor of the present invention who having a great interest in development of new energy sources has paid attention to the fact that there are so much energy wasted by the vehicles using inefficient engines which produce a large amount of exhaust gases containing harmful ingredients and heat dissipated along the roads to cause environmental pollution. How nice should it be possible to restore such wasted energies for reuse!

In a bid to tackle this problem, the present inventor has dedicated great efforts for years to studying and improving these defects and has come up with the on-road energy conversion and vibration absorber apparatus as provided in this invention that can be used to restore part of the vehicle even pedestrian's lost of energies on the road for reuse.

### SUMMARY OF THE INVENTION

It is an object of the resent invention to provide an on-load energy conversion and vibration absorber apparatus in which the kinetic energy received from moving vehicles (including motorcycles and bicycles) and pedestrians are able to be converted into a static energy using a restorable elastic element to compress and pressurize a fluid, and then to drive a vane wheel by releasing the pressure of the pressurized fluid. The vane wheel in turn drives a generator to generate electric energy.

It is another object of the present invention to provide an on-load energy conversion and vibration absorber apparatus that in addition to performing the energy conversion, the vibration of vehicles can also be absorbed and alleviated.

To achieve the above objects, the aforesaid apparatus comprises a restorable elastic compression unit to be laid on the road surface with a pressure receiver plate attached to the top thereof, and a pressure chamber is formed inside. The pressure receiver plate is for receiving the weights of those moving vehicles including motorcycles and bicycles and pedestrians weighing down thereon so as to compress and pressurize a fluid, mainly air, contained in the pressure chamber. An elastic compression unit is provided to support the pressure receiver plate and restore it to its initial position after the exerting weight is released. A fluid conduit with a check valve is installed abut on, and in connection with the pressure chamber, the check valve conducts the pressurized fluid to flow along the conduit in one direction and drives a vane wheel with a jet flow of the pressurized fluid by releasing it static energy. The vane wheel in turn drives a generator to generate electric energy. And the vibration of the vehicles is alleviated by the cushion effect of the restorable elastic element.

Meanwhile, the pressure receiver plate has a structure of a large square plate whose surface contains a number of small square grid shaped meshes, or patterned in a beehive configuration.

Other objects of the invention will be apparent to persons acquainted with apparatus of this general type upon reading the following specification and inspection of the accompanying drawings.

### BRIEF DESCRIPTION OF THE DRAWINGS

FIG. 1 is a perspective view of the present invention showing the relative position of a pressure receiver plate, restorable elastic element and pressure chamber.

FIG. 2 is a perspective view of the present invention showing the relative position of a pressure receiver plate, restorable elastic element, pressure chamber, check valve and fluid conduit.

FIG. 3 is a perspective view of the present invention showing the relative position of an extra governor valve in addition to the components shown in FIG. 2.

FIG. 4 is a perspective view of the present invention showing the relative position of a vane wheel in addition to the components shown in FIG. 3.

FIG. 5 is a perspective view of the present invention showing a generator is connected to the apparatus shown in FIG. 4.

FIG. 6 is a schematic view showing the surface pattern of the pressure receiving plate.

### DETAILED DESCRIPTION OF THE PREFERRED EMBODIMENT

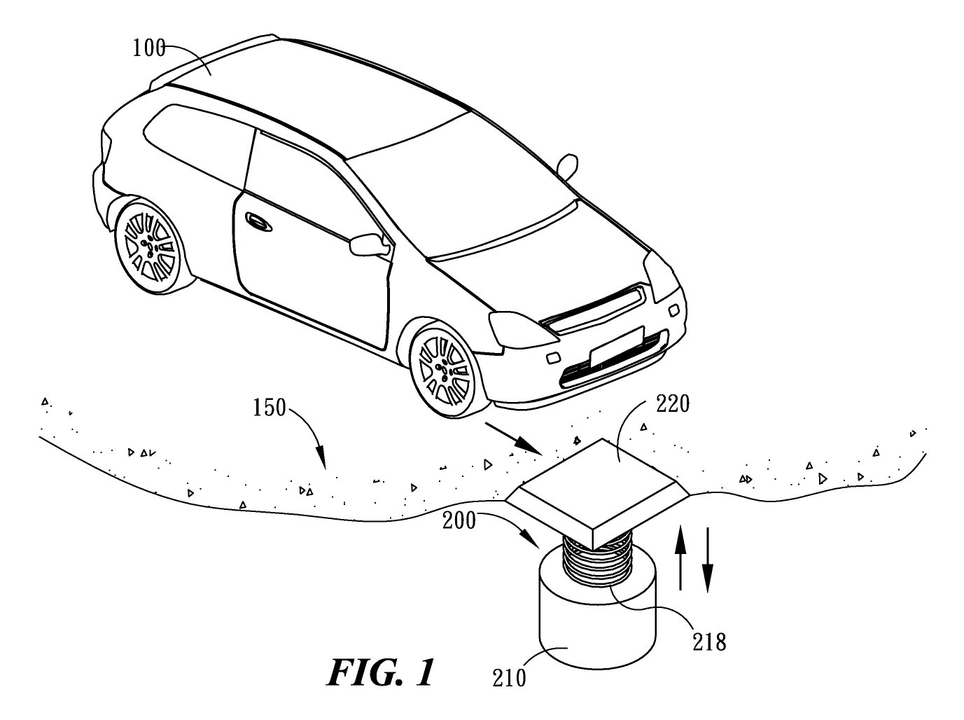

Referring to FIG. 1, the on-road energy conversion and vibration absorber apparatus receives the energy (static, kinetic energy of the rolling wheel) delivered by a vehicle 100 and even pedestrians when being weighed down on a pressure chamber 210 formed in a compression unit. The fluid contained in the pressure chamber 210 is pressurized to output a kinetic energy and at the same time, alleviating the vibration of the vehicle 100. In the apparatus, a compression unit 200 is installed beneath the road surface 150. When the vehicle 100 and pedestrians weigh down on a pressure receiver plate 220 of the compression unit 200, the fluid in the pressure chamber 210 is pressurized to store the static energy and then conducted to pass through a check valve 250 to flow in one direction, and the vibration of the vehicle is also alleviated by the cushion effect of the restoring force of the compression unit 200 performed by a restorable elastic element 218. The restorable elastic element 218 is a spring, or replaceable with the fluid in the pressure chamber 210. The fluid to be used is essentially air.

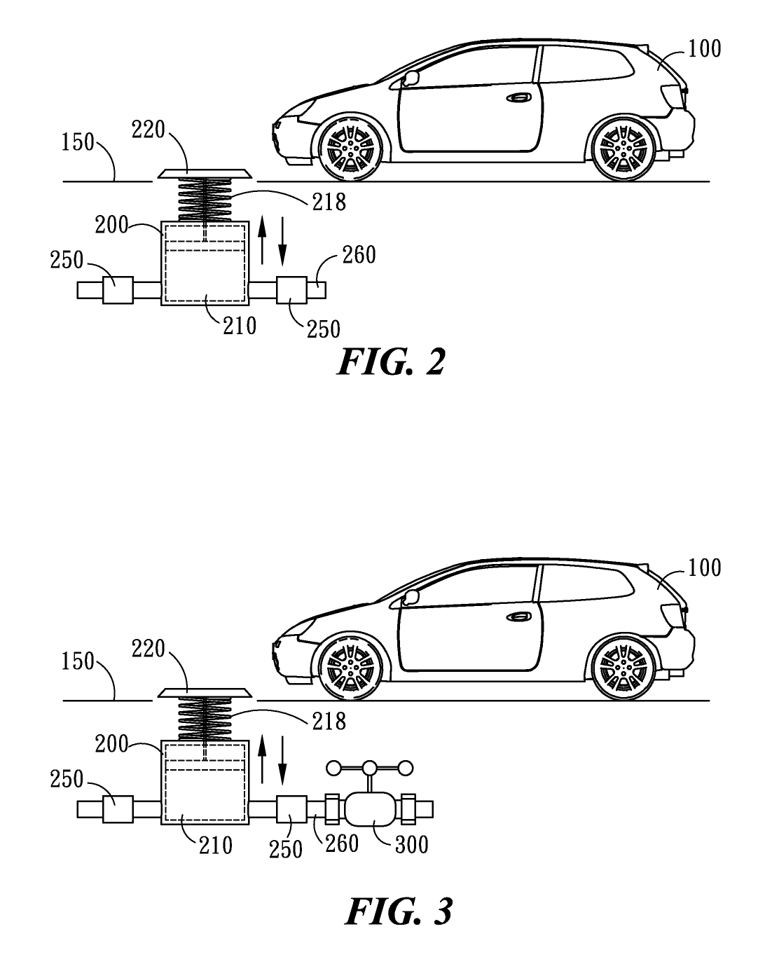

Referring to FIG. 2, in this embodiment, in addition to the component parts described in FIG. 1, a fluid conduit 260 is connected behind the check valve 250 to conduct the pressurized fluid to pass through in one direction along the fluid conduit 260 so as to make use of its kinetic energy.

Referring to FIG. 3, a governor valve 300 is provided to the exit of the fluid conduit 260 so as to control discharge of the fluid.

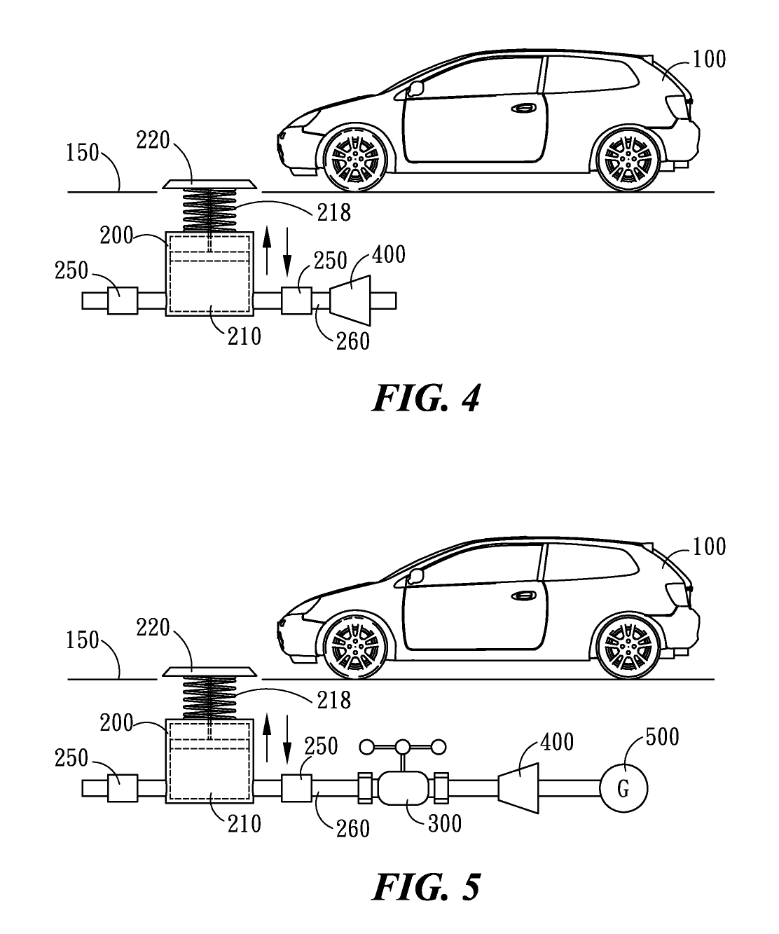

Referring to FIG. 4, the pressurized fluid discharged from the fluid conduit 260 is used to drive a vane wheel 400 (windmill, watermill) or a water spray gun by releasing its static energy.

Referring to FIG. 5, a generator 500 is connected to the vane wheel 400 or a water spray gun to be driven to generate electric energy.

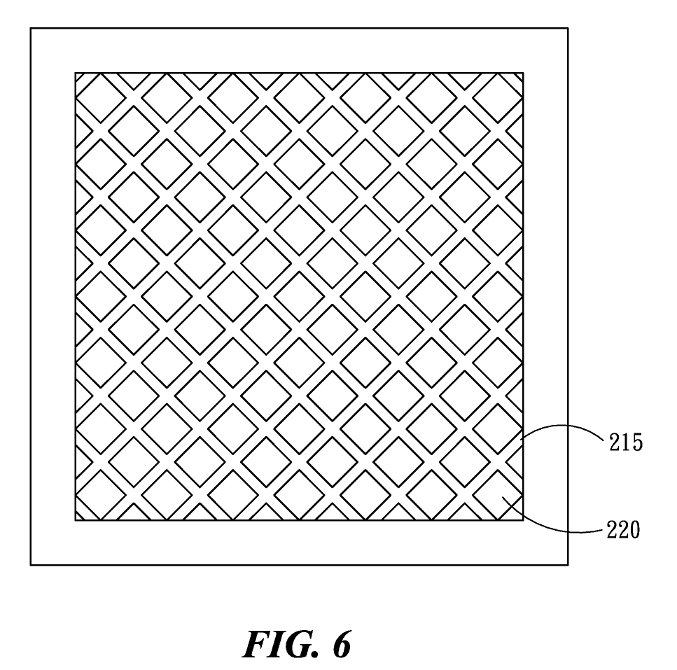

Referring to FIG. 6, the pressure receiver plate 220 has a structure of a large square plate whose surface contains a number of small square grid shaped meshes, or is patterned in a beehive configuration 215. After being liberated from the weight of the vehicle 100 or the pedestrian, the pressure receiver plate 220 recovers its initial state with the aid of the restorable elastic element 218 and ready for successively coming vehicles 100 or pedestrians to weigh down.

It is apparent to a person skilled in the art that the basic idea of the invention can be implemented in many different ways. The invention and its embodiments are thus not restricted to the examples described above, but may vary with the scope of the appended claims.

What is claimed is:

1. An on-road energy conversion and vibration absorber apparatus comprising:
a restorable compression unit to be laid on a road surface with a pressure receiver plate attached to the top thereof, and a pressure chamber formed inside, said pressure receiver plate being for receiving a weight of moving vehicles including motorcycles and bicycles and pedestrians to weigh down thereon so as to compress and pressurize a fluid, mainly air, contained in said pressure chamber;
an elastic element supporting said pressure receiver plate of the compression unit to restore the pressure receiver plate to its initial position after releasing an exerting weight;
with this structure, said restorable compression unit utilizes compressivibility of said fluid and converts said exerted weight into a static energy to store in said compression unit, and alleviating a vibration by cushion effect of said compression unit.

2. An on-road energy conversion and vibration absorber apparatus comprising:
a restorable compression unit to be laid on a road surface with a pressure receiver plate attached to the top thereof, and a pressure chamber formed inside, said pressure receiver plate being for receiving a weight of moving vehicles including motorcycles and bicycles and pedestrians to weigh down thereon so as to compress and pressurize a fluid, mainly air, contained in said pressure chamber;
an elastic element supporting said pressure receiver plate of the compression unit to restore the pressure receiver plate to its initial position after releasing an exerting weight; and
a fluid conduit with a check valve installed abut on, and in connection with said pressure chamber, said check valve for conducting said pressurized fluid to flow along said conduit in one direction to produce kinetic energy with a jet fluid flow;
with this structure, said restorable compression unit utilizes compressivibility of said fluid and converts said exerted weights into a static energy to store in said compression unit, and alleviating the vibration by cushion effect of said compression units.

3. The apparatus of claim 2, wherein a governor valve is provided to an exit of said fluid conduit so as to control discharge of said fluid.

4. The apparatus of claim 2, wherein a vane wheel or a water spray gun is employed to receive energy of said fluid.

5. The apparatus of claim 4, wherein the energy received by said vane wheel or water spray gun is used to drive a generator.

6. The apparatus of claim 2, said pressure receiver plate is structured in a large square plate whose surface contains a number of small square grid shaped meshes, or patterned in a beehive configuration, and brought back to its initial position after being liberated from the exerted weight by said restorable elastic element, said pressure receiver plate is in communication with said fluid conduit to transmit the received energy to said fluid.
